(19) United States
(12) Patent Application Publication
(10) Pub. No.: US 2009/0015525 A1
(43) Pub. Date: Jan. 15, 2009

(54) ELECTRO-OPTICAL DEVICE, METHOD OF CONTROLLING THE SAME AND ELECTRONIC APPARATUS

(75) Inventors: Hiroyuki HOSAKA, Matsumoto-shi (JP); Takashi TOYOOKA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/169,461

(22) Filed: Jul. 8, 2008

(30) Foreign Application Priority Data
Jul. 13, 2007 (JP) 2007-184026

(51) Int. Cl. G09G 3/32

(52) U.S. Cl. 345/82

(57) ABSTRACT

Light having a color component that corresponds to a present field is irradiated on a plurality of pixels for a time duration that starts during the scan period of the present field and that ends during the scan period of a next field that is subsequent to the present field. The light is irradiates so that the light having the color component that corresponds to the present field is not mixed with light having a color component that corresponds to a previous field that is previous to the present field and with light having a color component that corresponds to the next field

### BACKGROUND

1. Technical Field

The present invention relates to a technology of improving the brightness of a color display in a so-called color sequential (field sequential) method.

2. Related Art

In general, in a color sequential method, primary images of R (red), G (green) and B (blue) are repeatedly displayed in fields in time so as to perceptually synthesize the primary images, thereby performing a color display. However, in a case where an image and more particularly a moving image is displayed in the color sequential method, so-called color breakup occurs due to a deviation in display timing of the primary images of R, G and B. Accordingly, a technology of decomposing RGB components into at least four colors and sequentially displaying images of at least four colors is suggested (see JP-2005-233982 (FIG. 2)).

However, in this technology, in order to sequentially form the images of at least four colors, a driving speed of a display panel needs to be high and a processing circuit for decomposing the RGB components into at least four colors is separately required. Thus, the configuration becomes complicated.

### SUMMARY

An advantage of some aspects of the invention is that it provides an electro-optical device, a method of driving the same and an electronic apparatus, which are capable of preventing color breakup by a simple configuration.

According to an aspect of the invention, there is provided an electro-optical device, including: a plurality of pixels which are provided in correspondence with intersections between a plurality of scan lines and a plurality of data lines, a data signal supplied to a corresponding data line being held when a corresponding scan line is selected and a ratio of emitted light to incident light being changed according to the held data signal; a driving circuit which, when a frame period is divided into first, second and third fields corresponding to three different primary colors and each of the first, second and third fields are divided into a scan period and a return period, selects the plurality of scan lines in the scan period of the first, second or third field in a predetermined sequence and supplies the data signal according to a color component to the data line with respect to the pixel located at the selected scan line; and a light irradiation unit which makes light having a color component of a field incident to the plurality of pixels from the midst of the scan period of the field to the midst of the scan period of a next field of the field so as not to be mixed with light having a color component of a previous field of the field and light having a color component of a next field of the field. According to invention, the light having the color according to the field is irradiated in a portion of the scan period including the return time so as not to be mixed with the light having other colors. Accordingly, the light emitted from the pixels can brighten without deteriorating color reproduction. In addition, since a temporal deviation of the emitted light is reduced, color breakup can be suppressed. A frame period is a period necessary for the display of one sheet of color image and is about 16.7 milliseconds if 60 sheets of color images are displayed for 1 second.

In the invention, the light irradiation unit may irradiate light having a predetermined color by a color wheel or may include three LEDs which emit lights according to the three primary colors.

In this configuration, the light irradiation unit may allow the LED according to the color component supplied in the scan period to be in a turned-on state at an emission timing in the scan period of the field, and allow the LED according to the color component supplied in a previous scan period of the scan period to be in a turned-off state before the emission timing in the scan period of the field. If the light irradiation unit is composed of the LED, it is possible to simplify the configuration. The light irradiation unit may allow the emitted light to gradually brighten when the LED is in the turned-on state and allow the emitted light to gradually darken when the LED is in the turned-off state. If the quantity of light is gradually increased/decreased, the color is smoothly changed and influence on a display can be reduced.

The invention is applicable to a method of controlling the light irradiation of the electro-optical device and an electronic device including the electro-optical device, in addition to the electro-optical device.

### BRIEF DESCRIPTION OF THE DRAWINGS

The invention will be described with reference to the accompanying drawings, wherein like numbers reference like elements.

FIG. 1 is a block diagram showing the configuration of an electro-optical device according to an embodiment of the invention.

FIG. 2 is a circuit diagram showing the configuration of a pixel in the electro-optical device.

FIG. 3 is a view showing the configuration of a display panel in the electro-optical device.

FIG. 4 is a view showing the configuration of the display panel in the electro-optical device.

FIG. 5 is a view explaining the operation of the electro-optical device.

FIG. 6 is a view explaining the operation of an application example of the electro-optical device.

FIG. 7 is a view explaining the operation of another application example of the electro-optical device.

FIG. 8 is a view explaining the operation of a conventional electro-optical device.

### DESCRIPTION OF EXEMPLARY EMBODIMENTS

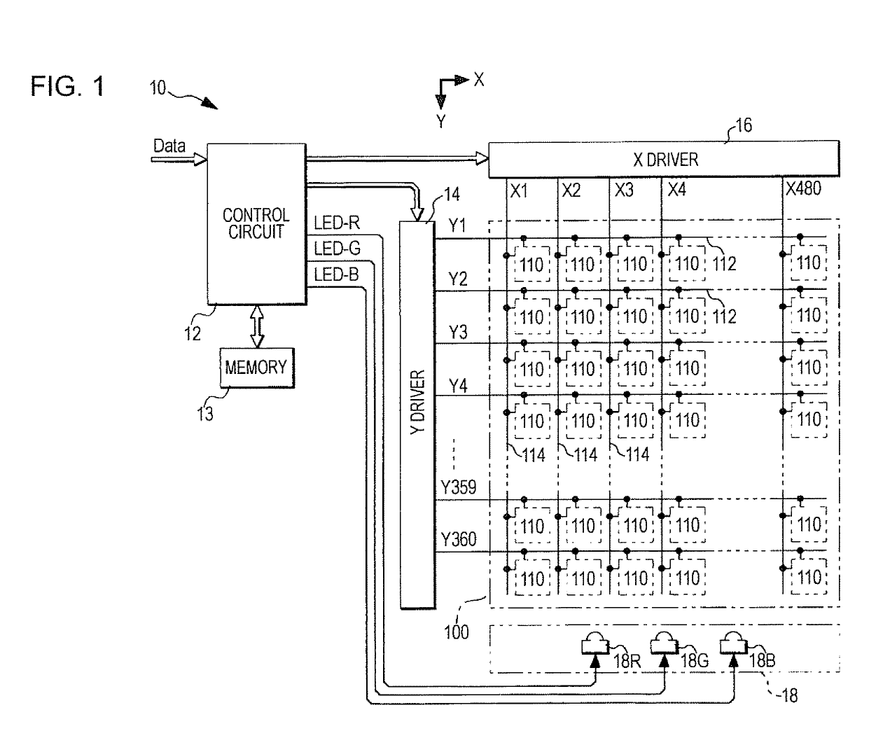

Hereinafter, embodiments of the invention will be described with reference to the accompanying drawings. FIG. 1 is a block diagram showing the configuration of an electro-optical device 10 according to an embodiment of the invention.

As shown in the drawing, the electro-optical device 10 includes a control circuit 12, a memory 13, a Y driver 14, an X driver 16, a light source 18 and a display panel 100. Among them, in the display panel 100, scan lines 112 of 360 rows are arranged in a horizontal direction (X direction) and data lines 114 of 480 columns are arranged in a vertical direction (Y direction). Pixels 110 are arranged at intersections between the scan lines 112 and the data lines 114. Accordingly, in the present embodiment, the pixels 110 are arranged in a 360×480 matrix.

The control circuit 12 controls the operations of the components of the electro-optical device 10. In more detail, the control circuit 12 transmits display data Data supplied from a host device (not shown) to the memory 13, stores the display data in the memory, reads the display data Data from the memory 13 in synchronization with vertical scan and horizontal scan of the display panel 100, and supplies the display data to the X driver 16. For vertical scan and horizontal scan, the control circuit 12 supplies a clock signal necessary for the Y driver 14 and the X driver 16.

Here, the display data Data is data which is supplied from the host device so as to specify the brightness (gradation value) of each pixel for each of the primary colors of RGB. In the present embodiment, as described below, since a frame period (a vertical scan period) is divided into three consecutive fields in each of the colors of RGB, the display data Data supplied from the host device is stored in the memory 13, and the display data having a corresponding color component is read in each field and is supplied to the X driver 16. The control circuit 12 controls the emission and the non-emission of each color by the light source 18.

The Y driver 14 supplies scan signals to the scan lines 112 of the first to 360th rows, of which the detailed operation will be described later. Here, the scan signals supplied to the scan lines 112 of the first, second, third, . . . , and 360th rows are denoted by Y1, Y2, Y3, . . . , and Y360 in the drawing, respectively.

The X driver 16 converts display data of one row of pixels located at a selected scan line 112 into data signals having a voltage suitable for driving of liquid crystal and supplies the data signals to the pixels 110 via the data lines 114. Here, the data signals supplied to the data lines 114 of the first, second, third, . . . , and 480th columns are denoted by X1, X2, X3, . . . , and X480 in the drawing, respectively. Accordingly, a combination of the Y driver 14 and the X driver 16 is defined as a driving circuit.

As shown in FIG. 3, in the display pane 100, a counter substrate 101 and a device substrate 102 are attached to each other at a predetermined gap therebetween and liquid crystal is filled in the gap. A common electrode or the like is formed on an opposing surface of the counter substrate 101 and a pixel electrode or the like is formed on an opposing surface of the device substrate 102.

The light source 18 includes a red LED 18R, a green LED 18G and a blue LED 18B.

A backlight unit 105 uniformly irradiates light emitted from the light source 18 to the device substrate 102. Accordingly, a combination of the light source 18 and the backlight unit 105 is defined as a light irradiation unit.

The emission of the LEDs in the light source 18 is controlled by the control circuit 12. In more detail, the red LED 18R is turned on so as to emit light when a control signal LED-R becomes a H level and is turned off so as not to emit light when the control signal LED-R becomes an L level. Similarly, the green LED 18G and the blue LED 18B are turned on so as to emit light when control signals LED-G and LED-B becomes a H level and are turned off so as not to emit light when the control signals LED-G and LED-B become an L level.

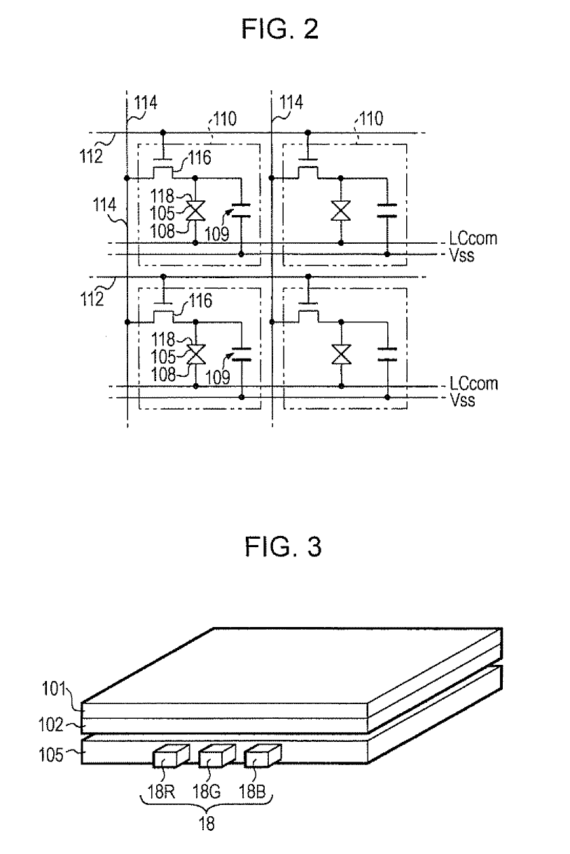

Next, the configuration of the pixel 110 will be described with reference to FIG. 2.

As shown in the drawing, in the pixel 110, a source electrode of an n-channel type thin-film transistor (TFT) 116 is connected to the data line 114, a drain electrode thereof is connected to a pixel electrode 118, and a gate electrode thereof is connected to the scan line 112.

The common electrode 108 is commonly provided with respect to all the pixels so as to face the pixel electrode 118 and, in the present embodiment, a constant voltage LCcom is applied to the common electrode. A liquid crystal layer 105 is interposed between the pixel electrode 118 and the common electrode 108. Accordingly, a liquid crystal capacitor composed of the pixel electrode 118, the common electrode 108 and the liquid crystal layer 105 is formed.

Although not specially shown, alignment films which are rubbed such that long-axis directions of liquid crystal molecules are consecutively twisted by about 90 degrees between the both substrates are provided on the opposing surfaces of the both substrates and polarizers are provided on the rear surfaces of the both substrates such that the transmission axes thereof are arranged in alignment directions.

Accordingly, the light passing through the pixel electrode 118 and the common electrode 108 rotates by about 90 degrees by the twist of the liquid crystal molecules if an effective value of the voltage held in the liquid crystal capacitor is zero. Thus, transmissivity of the light becomes a maximum. In contrast, as the effective value of the voltage is increased, the liquid crystal molecules are tilted in an electric field direction and thus a rotation property disappears. Accordingly, the quantity of transmitted light is reduced and thus transmissivity of the light becomes a minimum (normally white mode).

Accordingly, if the backlight unit 105 emits the light to the device substrate 102, the irradiated light is emitted with a ratio according to the effective value of the voltage held in the liquid crystal capacitor in each pixel.

A storage capacitor 109 is formed in each pixel in order to reduce the influence of leakage of charges from the liquid crystal capacitor via the TFT 116. One end of the storage capacitor 109 is connected to the pixel electrode 118 (the drain of the TFT 116) and the other end thereof is grounded to a low-potential voltage Vss in each pixel.

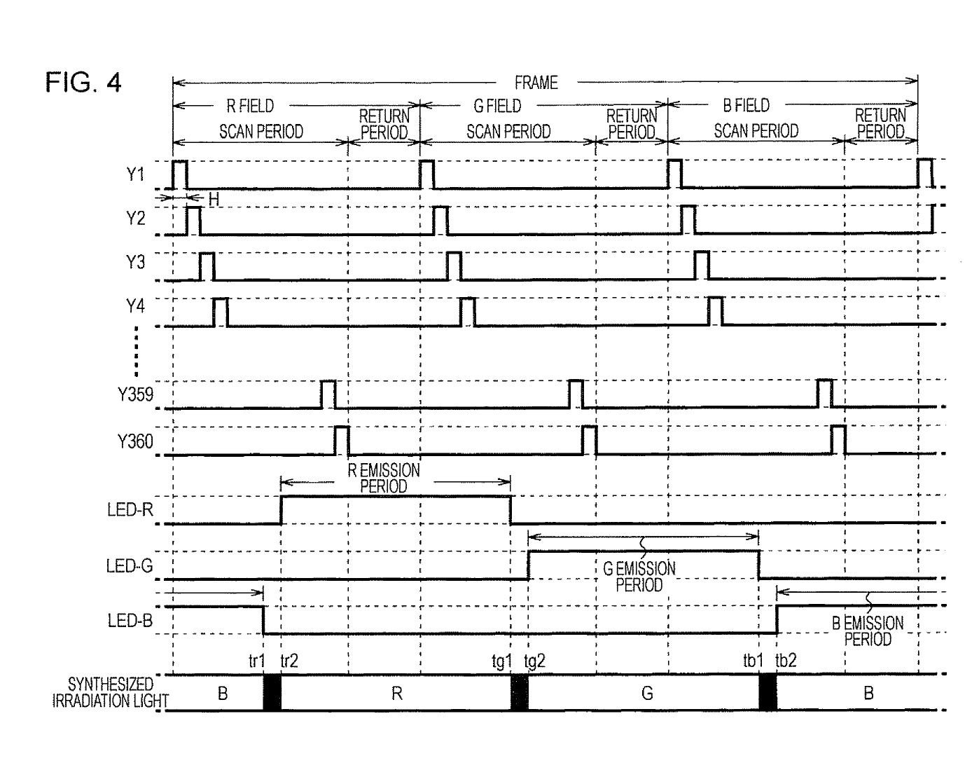

Next, the operation of the electro-optical device 10 according to the present embodiment will be described. FIG. 4 is a timing chart showing the operation of the electro-optical device 10.

As shown in the drawing, in the present embodiment, a frame period is divided into three fields, that is, an R field, a G field and B field corresponding to RGB. In each field, the control circuit 12 controls the Y driver 14 so as to sequentially select the scan lines 112 of the first, second, third, t . . . , and 360th rows in each horizontal scan period H from the top in FIG. 1. Accordingly, as shown in FIG. 4, in the scan period of each field, the scan signals Y1, Y2, Y3, . . . , and Y360 become sequentially the H level.

In the scan period of each field, the control circuit 12 controls the Y driver 14 so as to output the scan signals Y1 to Y360 and controls the X driver 16 as follows. That is, the control circuit 12 controls the X driver such that, in the case where the scan signals Y1 to Y360 sequentially become the H level in the scan period of the R field, when attention is focused on the scan line of any row, before the scan signal supplied to the focused row becomes the H level, display data Data of the pixels of one row located at the scan line of the focused row, that is, display data of the R component, is previously read from the memory 13 and is transmitted to the X driver 16, and the display data Data of the R component transmitted to the X driver 16 is converted into the data signal and is output to the data lines of the first to 320th columns when the scan signals of the focused row become the H level.

Accordingly, the X driver 16 outputs the data signals X1, X2, X3, . . . , and X480 of the pixels located at the focused row, that is, the data signals having the voltage according to the gradation of the R component, to the data lines 114 corresponding to the column.

When the scan signals supplied to the focused row become the H level, since the TFTs 116 of the pixels 110 located at the scan line 112 of the focused row are turned on, when attention is focused on the data line 114 of any column, the voltage of the data signal of the focused column is written to the pixel electrode 118 of the pixel located at the intersection between the selected scan line 112 and the data line 114 of the focused column when the scan signal supplied to the scan line of the focused row becomes the L level, the TFTs 116 of the pixels 110 located at the scan line 112 of the focused row are turned off, but the voltage written to the pixel electrodes are held by the capacitance of the liquid crystal capacitor.

Since the write operation of one row is performed in order of the first, second, third, . . . , and 360th rows in the scan period of the R field, in a return period after the scan period, the voltage according to the R component is held in all the liquid crystal capacitors.

Even in the subsequent scan periods of the C field and the B field, the same write operation is performed. Accordingly, in the return period after the scan period of the G field, the voltage according to the G component is held in all the liquid crystal capacitors and, in the return period after the scan period of the B field, the voltage according to the B component is held in all the liquid crystal capacitors.

With respect to the write operation of the display panel 100, the control circuit 12 outputs the control signals LED-R, LED-G and LED-B and controls the red LED 18R, the green LED 18G and the blue LED 18B.

That is, as shown in FIG. 4, the control circuit 12 allows the control signal LED-R to become the H level from a timing tr2 in the scan period of the R field to a timing tg1 in the scan period of the G field, allows the control signal LED-G to become the H level from a timing tg2 later than a timing tg1 in the scan period of the G field to a timing tb1 in the scan period of the B field, and allows the control signal LED-B to become the H level from a timing tb2 later than a timing tb1 in the scan period of the B field to a timing tb1 earlier than a timing tr2 in the scan period of the R field of a next frame.

By the control signals LED-R, LED-G and LED-B, in a period from the timing tr2 to the timing tg1, including the return time of R, only the red LED 18R emits the light and thus the light irradiated to the display panel 100 becomes R (red) color and, in a period from the timing tg2 to the timing tb1, including the return time of S, only the red LED 18G emits the light and thus the light irradiated to the display panel 100 becomes G (green) color. In addition, in a period from the timing tb2 to the timing tr1 of the next frame, including the return time of B, only the red LED 18B emits the light and thus the light irradiated to the display panel 100 becomes B (blue) color.

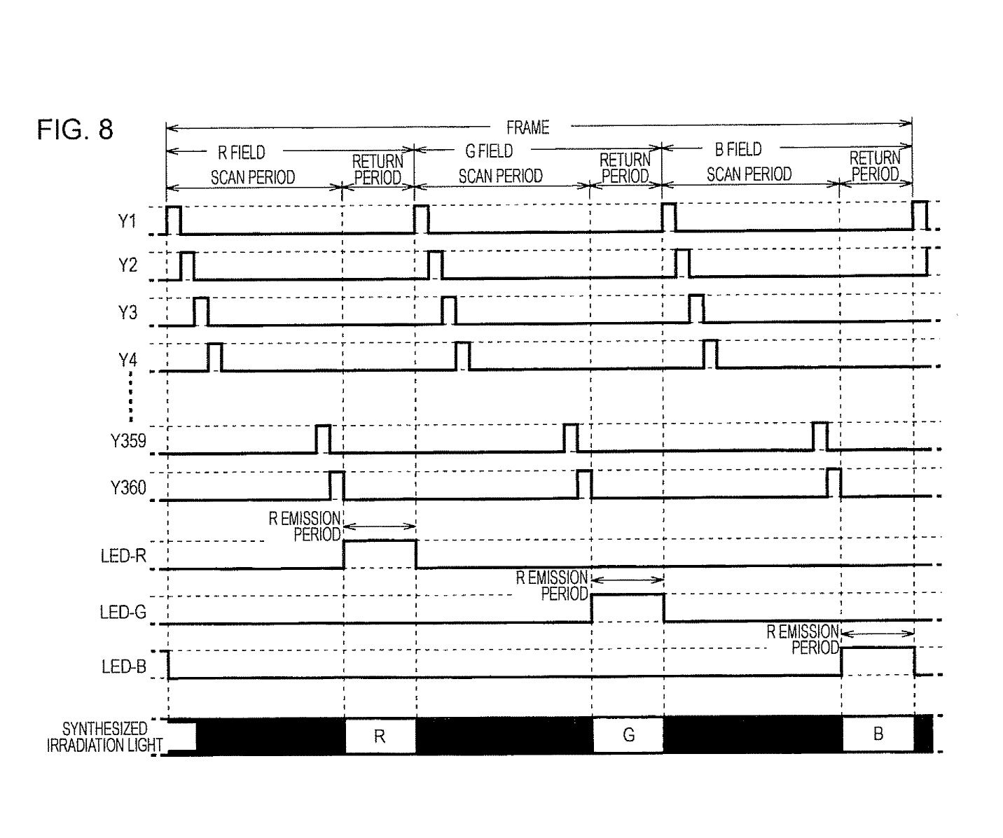

However, in a known color sequential method, as shown in FIG. 8, only the red LED 18R emits light only in the return time of the R field in which the voltage according to the R component is held in all the liquid crystal capacitors and only the green LED 18G and the blue LED 18B respectively emit light only in the return times of the G and B fields in which the voltage according to the G and B components is held in all the liquid crystal capacitors. Accordingly, in the conventional color sequential method, a whole screen darkens and periods in which the images of the primary colors of R, G and B are viewed are deviated in time. Thus, color breakup is susceptible to be perceived.

In contrast, in the present embodiment, since the lights of R, C and B are irradiated to the display panel 100 in the return times of the R, G and B fields and the scan periods before and after the return times, the whole screen brightens and the temporal deviation in the period in which the images of the respective colors are viewed is small. Thus, it is possible to suppress color breakup.

In addition, since the method for driving the display panel 100 is equal to the known method and only the control of the red LED 18R, the green LED 18G and the blue LED 18B is different from that of the known method, the complication of the configuration is avoided.

In the present embodiment, in a period up to the timing tr1 of the scan period of the R field, the light of B is irradiated to the display panel 100 but many pixels, in which the voltage according to the B component in the previous B field is held, exist. Accordingly, the influence on the viewed image by is low by irradiating the light of B. Similarly, in a period up to the timing tg1 (tb1) of the scan period of the G (B) field, the light of R (G) is irradiated to the display panel 100 but many pixels, in which the voltage according to the R (G) component in the previous R (G) field is held, exist. Accordingly, the influence on the viewed image by is low by irradiating the light of R (G).

In the scan period of the R field, since the pixel in which the voltage according to the B component in the previous B field is still held and the pixel to which the voltage according to the R component in the R field is rewritten coexist, for the purpose of brightening the screen, a configuration, in which, in the scan period of the R field, with respect to the pixels of the B and R components, the lights of B and R are simultaneously emitted so as to irradiate light of M (magenta), in the scan period of the G field, the lights of R and G are simultaneously emitted so as to irradiate light of Y (yellow), and, in the scan period of the B field, the lights of G and B are simultaneously emitted so as to irradiate light of C (cyan), may be considered. However, in this configuration, since the light of unintended color passes through the liquid crystal capacitor so as to be viewed, color reproduction deteriorates.

In contrast, in the present embodiment, in order to prevent the mixed color from passing through the liquid crystal capacitor, in periods from tr1 to tr2, tg1 to tg2 and tb1 to tb2, the red LED 18R, the green LED 18G and the blue LED 18B are turned off. Thus, it is possible to prevent color reproduction from deteriorating due to the mixed color.

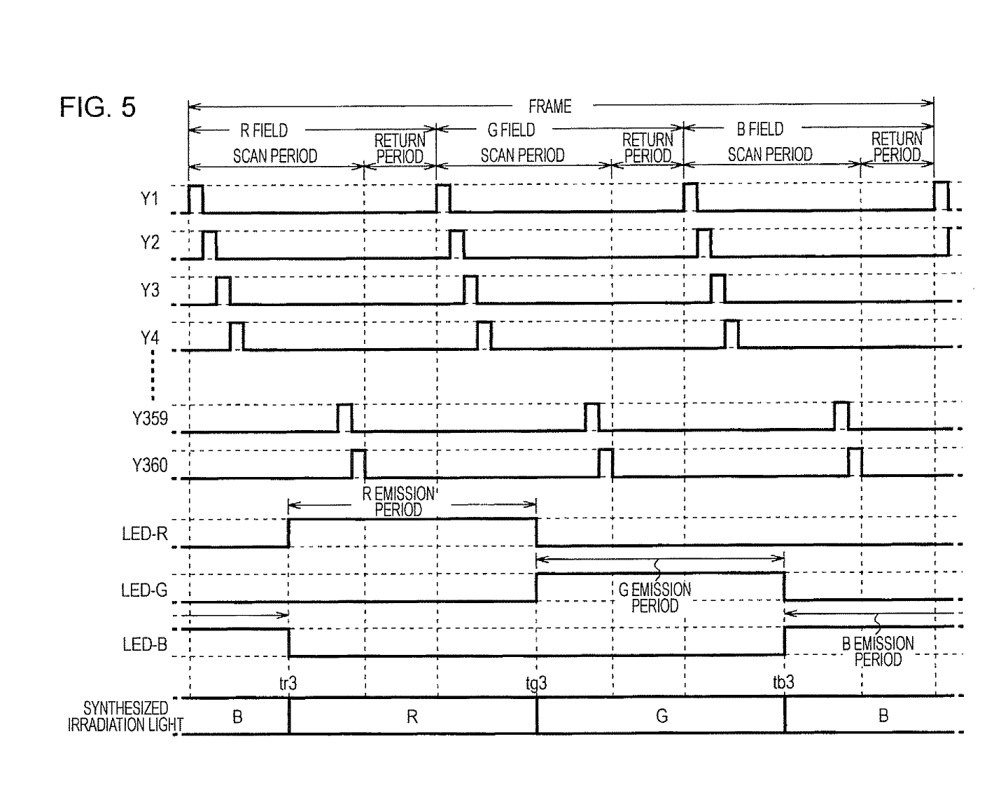

From the viewpoint of the prevention of the deterioration of the color reproduction due to the mixed color, as shown FIG. 5, the turned-off of the blue LED 18B and the turned-on of the red LED 18R may be simultaneously performed at a timing tr3 in the scan period of the R field, the turned-off of the red LED 18R and the turned-on of the green LED 18G may be simultaneously performed at a timing tg3 in the scan period of the G field, and the turned-off of the green LED 18G and the turned-on of the blue LED 18B may be simultaneously performed at a timing tb3 in the scan period of the B field.

If the turned-on and the turned-off are simultaneously performed, color breakup is suppressed and the whole screen further brightens.

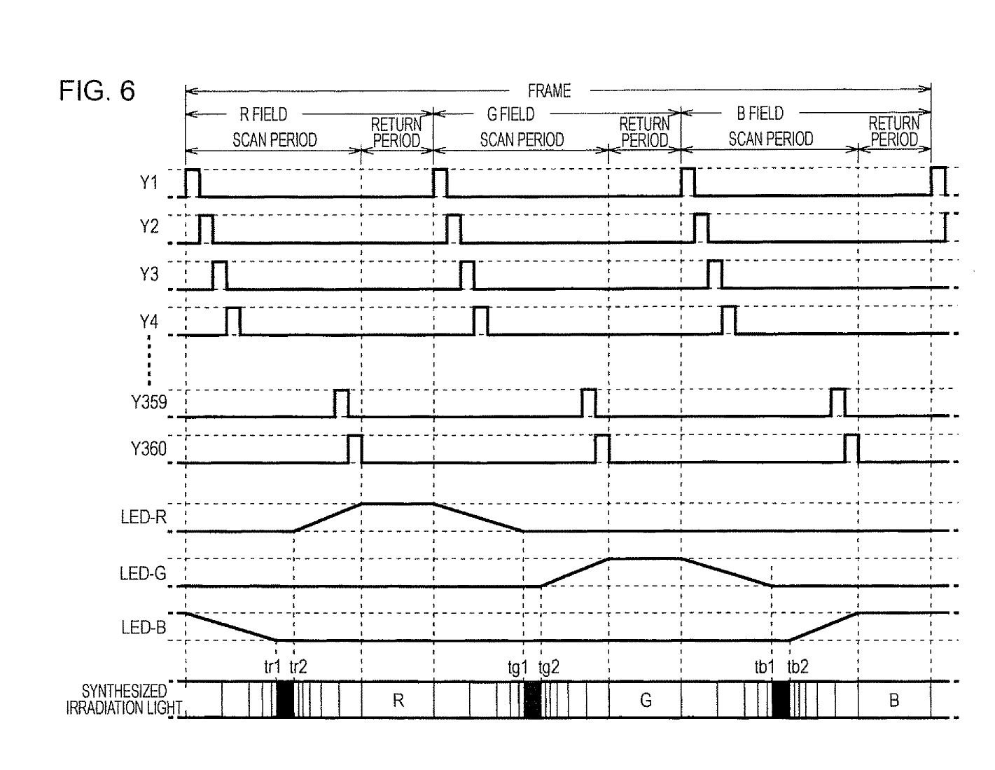

Instead of the control of the turned-on and the turned-off of the red LED 18R, the green LED 18G and the blue LED 18B in a binary manner, as shown in FIG. 6, when the turned-off state is changed to the turned-on state, the light may gradually brighten from the turned-off state. In contrast, when the turned-on state is changed to the turned-off state, the light may gradually darken from the turned-on state.

If the brightness is gradually changed, the color is smoothly changed in addition to the suppression of color breakup and the increase of the brightness of the whole screen. Thus, the influence on the perceived image can be reduced.

Although, in the above-described embodiment, the display panel 100 forms the images having the three primary colors of R (red), green (G) and B (blue), primary colors having the components different from the color components may be formed so as to control the irradiation of the lights having the colors according to the color components. Since the image data supplied from the host device is supplied for each of the components of RGB, a configuration for converting the color components of the image data is necessary.

Although, in the above-described embodiment, the color of the light irradiated to the display panel 100 is changed using the red LED 18R, the green LED 18G and the blue LED 18B, the color of the light irradiated to the display panel 100 may be changed by rotating a color wheel colored with the same colors as the synthesized irradiation lights of FIGS. 4, 5 and 6 in synchronization with the drive of the display panel 100 and transmitting white light by a white LED.

Although, in the above-described embodiment, a normally white mode for performing a white display is set in the case where the effective voltage values of the common electrode 108 and the pixel electrode 118 are small, a normally black mode for performing a black display may be set.

Although, in the embodiment, TN type liquid crystal is used as liquid crystal, bi-stable twisted nematic (BTN) type liquid crystal having a memory property such as a BTN type or a ferroelectric type, polymer dispersed type liquid crystal, or guest-host (GH) type liquid crystal obtained by dissolving dye (guest) having anisotrophy in absorption of visible light in a long-axis direction and a short-axis direction of molecules in the liquid crystal (host) of a constant molecule arrangement and arranging dye molecules in parallel to liquid crystal molecules may be used.

A vertical alignment (homeotropical alignment) configuration in which liquid crystal molecules are arranged in the vertical direction of the both substrates when a voltage is not applied and are arranged in the horizontal direction of the both substrates when the voltage is applied may be used. A horizontal alignment (homogeneous alignment) configuration in which liquid crystal molecules are arranged in the horizontal direction of the both substrates when the voltage is not applied and are arranged in the vertical direction of the both substrates when the voltage is applied may be used. In the present invention, a variety of liquid crystal or alignment methods is applicable.

The invention is not limited to a transmission type and is applicable to a reflection type device. The invention is not limited to the liquid crystal capacitor and is applicable to a digital mirror device.

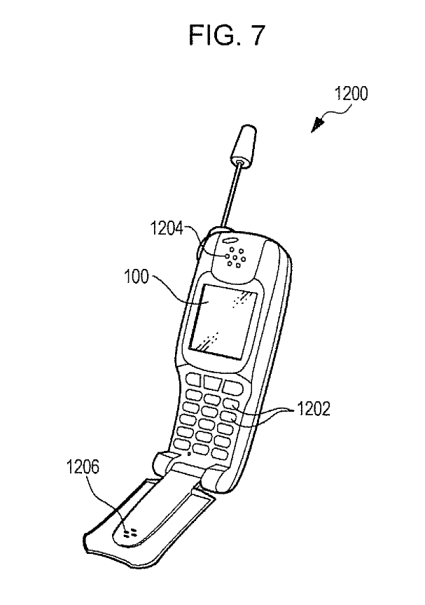

Next, an electronic apparatus using the electro-optical device 10 inspected as described above will be described. FIG. 7 is a perspective view showing the configuration of a mobile telephone in which the electro-optical device 10 is applied to a display unit.

In the drawing, the mobile telephone 1200 includes a plurality of operation buttons 1202, an earpiece 1204, a mouthpiece 1206, and an electro-optical device 10. In addition to the electronic apparatus described in FIG. 6, there is a direct-view apparatus such as a liquid crystal TV set, a viewfinder-type or direct-view monitor type video tape recorder, a car navigation system, a pager, an electronic organizer, an electronic calculator, a word processor, a workstation, a videophone, a POS terminal, or a touch-panel-equipped device or a projection apparatus such as a projector for forming, expanding and projecting a reduced image.

The entire disclosure of Japanese Patent Application No. 2007-184026, filed Jul. 13, 2007 is expressly incorporated by reference herein.

What is claimed is:

1. An electro-optical device, comprising:
a plurality of pixels provided in correspondence with intersections between a plurality of scan lines and a plurality of data lines, a data signal supplied to a corresponding data line being held when a corresponding scan line is selected;
a driving circuit which:
selects the plurality of scan lines in the scan period of first, second, or third field of a frame period in a predetermined sequence, the first, second, and third fields of the frame period corresponding to three different primary colors and each of the first, second, and third fields being divided into a scan period and a return period, and
supplies the data signal according to a color component to the data line with respect to the pixel located at the selected scan line; and
a light irradiation unit which irradiates light having a color component that corresponds to a present field on the plurality of pixels for a time duration that starts during the scan period of the present field and that ends during the scan period of a next field that is subsequent to the present field, so as not to mix the light having the color component that corresponds to the present field with light having a color component that corresponds to a previous field that is previous to the present field and light having a color component that corresponds to the next field.

2. The electro-optical device according to claim 1, wherein the light irradiation unit includes three LEDs which emit lights according to the three primary colors.

3. The electro-optical device according to claim 2, wherein the light irradiation unit allows the LED according to the color component supplied in the scan period to be in a turned-on state at an emission timing in the scan period of the field, and allows the LED according to the color component supplied in a previous scan period of the scan period to be in a turned-off state before the emission timing in the scan period of the field.

4. The electro-optical device according to claim 3, wherein the light irradiation unit allows the emitted light to gradually brighten when the LED is in the turned-on state and allows the emitted light to gradually darken when the LED is in the turned-off state.

5. A method of controlling an electro-optical device, the electro-optical device comprising:
a plurality of pixels provided in correspondence with intersections between a plurality of scan lines and a plurality of data lines, a data signal supplied to a corresponding data line being held when a corresponding scan line is selected
a driving circuit which:
selects the plurality of scan lines in the scan period of first, second, or third field of a frame period in a predetermined sequence, the first, second, and third fields of the frame period corresponding to three different primary colors and each of the first, second, and third fields being divided into a scan period and a return period, and
supplies the data signal according to a color component to the data line with respect to the pixel located at the selected scan line, the method comprising:
irradiating light having a color component that corresponds to a present field on the plurality of pixels for a time duration that starts during the scan period of the present field and that ends during the scan period of a next field that is subsequent to the present field, so as not to mix the light having the color component that corresponds to the present field with light having a color component that corresponds to a previous field that is previous to the present field and light having a color component that corresponds to the next field.

6. An electronic apparatus comprising the electro-optical device according to claim 1.
